(19) United States
(12) Patent Application Publication
(10) Pub. No.: US 2008/0053235 A1
(43) Pub. Date: Mar. 6, 2008

(54) MICROSCOPIC ACOUSTIC RADIATION DETECTING APPARATUS AND METHOD

(76) Inventor: William J. Peria, Seattle, WA (US)

Correspondence Address: AXIOS LAW GROUP. PLLC, 1525 FOURTH AVENUE, SUITE 800, SEATTLE, WA, 98101, US

(21) Appl. No.: 11/844,285

(22) Filed: Aug. 23, 2007

Related U.S. Application Data
(60) Provisional application No. 60/824,259, filed on Aug. 31, 2006.

(51) Int. Cl. G01H 9/00

(52) U.S. Cl. 73/655

(57) ABSTRACT

An acoustic radiation detecting apparatus and method are provided herein.

### RELATED REFERENCES

This application is based upon and claims the benefit of priority from Provisional Application No. 60/824,259 filed Aug. 31, 2006, the entire contents of which are incorporated herein by reference.

### BACKGROUND

The final result of many experiments in modern biology is a measurement of the expression profile of cultures of cells which have been treated in specifically prescribed ways. In other words, how did the cells in the culture respond to a given set of conditions? What enzymes or other proteins did they produce, and in what quantities? Did they fail to produce particular proteins? If one could grow cells individually rather than in cultures, exposing each to slightly different conditions throughout its life cycle, and then accurately measure the expression profile of each single cell separately, progress on the many open questions in modern biology would accelerate significantly. The quantitation of proteins is currently done with Tandem Mass Spectrometry (MS/MS). MS/MS requires large sample sizes, usually larger than what is available from a single cell. However, the data from MS/MS are often ambiguous, and the protein content of a sample may be reconstructed from the mass spectrum using various techniques, such as time-consuming maximum likelihood methods.

Many technologies exist for the detection of various biological processes and events. Circular dichroism spectroscopy (CD) can detect large changes in the folded fraction of a bulk sample of proteins in solution, for proteins which fold at modest speeds. But a CD spectrum represents only an average over many molecules, and does not yield any information on the folding process in a single molecule. To track fast-folding proteins, CD requires an intense and costly light source (such as the ALS at the Lawrence Berkeley Lab), but again, only the aggregate folded fraction is detected, not single protein molecules.

Fluorescence Resonant Energy Transfer (FRET) is a single molecule method which can track the progress of a folding protein, but it yields information about a limited number of residues only, a small fraction of the number found in a typical globular protein. Furthermore, the information from FRET is simply that pairs of residues either are or are not in close contact, and to some extent, how close that contact is. Hence, FRET measures only degree of progress along the path to the native state, and does not supply information about the nature of the processes which lead to the native state.

“Yeast Songs” can be detected with Atomic Force Microscopy (AFM), but only up to frequencies significantly less than 100 kHz. Furthermore, AFM requires direct mechanical contact with a yeast cell in vivo.

The sequencing of nucleic acids currently requires a substantial amount of sample material, which may usually be amplified via the polymerase chain reaction (PCR). At present, several minutes are needed to determine a single nucleotide in a sequence with reasonable confidence. Thus, the determination of sequences of significant lengths requires a high degree of parallelization and automation.

### BRIEF DESCRIPTION OF THE DRAWINGS

FIG. 1 is an illustration of a novel laser inferometer that can detect acoustic radiation from microscopic sources in accordance with one embodiment.

FIG. 2 is a schematic diagram of a noise-canceling circuit in accordance with one embodiment.

### DESCRIPTION

Various embodiments described herein provide an instrument capable of detecting acoustic radiation from microscopic sources, which would enable advances in several areas. One could determine the protein (enzymes, etc.) composition of very small volume samples, enabling single-cell biological experimentation. The step-by-step detailed temporal history of numerous cellular processes could be studied. The folding of single protein molecules could be tracked in real time. Metabolically-driven motions of the cell walls of yeast (“yeast songs”) could be detected and monitored with bandwidths of 1 MHZ or more, in vivo and without mechanical contact. Clues as to the functioning of flagella and other motor proteins could be obtained. The docking of enzymes could be detected, and protein-protein interactions could be detected, specified, and their processes revealed. A catalog of “sounds” typical of all of these processes could be produced. In particular, the cataloguing of the sounds produced by the folding of known proteins would allow for protein quantitation in cellular or even sub-cellular volume samples of unknown composition. Nucleic acids could be sequenced at the same rate at which they are synthesized by their polymerases. A single nucleic acid strand would represent a sufficient quantity of material for sequencing, whether for forensic or clinical purposes.

These “microsounds” will be detected essentially as ripples produced on the surface of a comparatively large-volume vessel for aqueous samples. Samples can be introduced into the detector system in vivo, using a generic sample holder adaptable for general purposes. Alternatively, a microfluidic system for introducing fluid samples of various kinds will be available. For example, a solution of denatured proteins (with either heat or various chemical denaturants) could be made to flow steadily into the system. As the denaturant diffuses away from the slow-diffusing protein (or other macromolecule), protein folding motions (conformational changes) will occur and be detected. An additional microfluidic input of de-ionized water and also a steady drain will be provided, to prevent the accumulation of denaturing compounds or other contaminants.

Numerous processes in living cells and other macromolecular systems involve abrupt motions of rigid components—components which are orders of magnitude larger than a water molecule. Some examples of these abrupt motions are the folding of proteins, the docking of enzymes, the spinning of flagella, the supercoiling of DNA, and the addition of nucleotides during nucleic acid synthesis. Each of these motions involves the simultaneous acceleration of hundreds or thousands of water molecules, with energies comparable to or larger than the thermal energy. This is the essential and generic requirement for the sourcing of acoustic radiation: the otherwise improbable synchronous localized perturbation of the momenta of many molecules in a fluid medium. Such a perturbation (the direct transfer of momentum from a macromolecule to its surrounding water molecules) then propagates away from the source as an acoustic wave.

The detection of acoustic radiation from microscopic sources will be accomplished using a novel laser interferometer. Motions of the air-water interface at the free surface of the vessel containing the sample being studied will be converted into relative phase shifts between two interfering laser beams. These phase shifts appear as intensity variations in the combined beam, and these can be measured and recorded.

The interferometer described here consists of a light source, optics—for beam expanding, isolating, splitting, focusing, and steering; a sample vessel, a mechanical alignment system, a mechanical isolation system, an active liquid surface stabilization system, and sample delivery systems.

A source of steady coherent light may be used. The coherence length may be substantially greater than the size of the sample vessel, i.e. most gas or diode lasers are suitable, although multi-mode “ultra-low noise” units may not be. The laser wavelength may be sufficiently long so as not to break hydrogen bonds in the macromolecules under study, nor to otherwise damage cells. The 635 nm, 5 mW LabLaser (#31-0128-000 from Coherent Inc, Auburn, Calif.) is suitable. The laser may be placed in an aimable mechanical mount to facilitate alignment (e.g., Coherent 0221-449-000). The laser may have its major polarization axis oriented vertically.

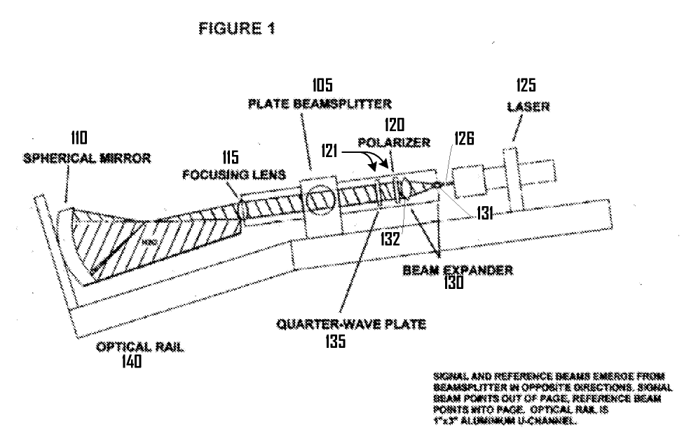

The laser source beam 126 may be expanded in diameter to improve its focusing properties and increase its immunity to local surface defects in optical elements. Such a beam expander 130 is illustrated in FIG. 1. A pair of lenses held in alignment with standard C-mount components, such as those available from Edmund Industrial Optics (EO) of Barrington, N.J., can achieve this. A small (but somewhat larger than the source beam) concave lens 131 (EO 45-373) is used to make the source beam 126 divergent. A larger convex lens (EO 47-347) is then used to collimate the source beam 132. The expansion ratio is equal to the ratio of the focal length of the large lens 132 to that of the small lens 131. The large lens 132 may be larger than the small lens 131 by somewhat more than this ratio. All lenses may be coated to minimize stray reflections. Alternately, a piano-concave lens is used, it may be oriented so that the concave side faces the laser 125, to spread any residual back-reflection over a large area. The expanded source beam may be put through a polarizer 120 (EO 47-216) with the transmission axis oriented vertically.

The expanded and polarized source beam 126 may be passed through a zero order quarter-wave plate 135 tuned for 635 nm (EO 43-700). The slow axis of the quarter-wave plate 135 may be aligned at 45 degrees from vertical. The quarter-wave plate 135 causes the laser beam to have a horizontal polarization on return, and thus it will be blocked by the vertical polarizer 120 and prevented from re-entering the laser cavity.

After passing through the optical isolation system 121 (quarter-wave plate 135 and polarizer 120), the source beam may be split into two equal intensity components. One will pass through the interferometer and will be called the signal beam. The other will be used as a reference beam to eliminate both residual intensity noise produced in the laser cavity (e.g., through mode-hopping), and additional intensity modulation produced by interfering stray reflections in the interferometer. A thin plate-glass beam splitter 105 (EO 54-824) with a 50-50 splitting ratio may be used.

The signal beam may be focused to a sufficiently small spot. A single lens 115 (EO 47-364) in a simple fine focusing mount (EO 03-625) is adequate for this purpose. The focusing lens 115 may be large enough to avoid vignetting the signal beam, and its focal length may be at least approximately 10 times as great as its diameter, so that the lens will be above the water's surface in spite of the low incidence angle of the beam to the water (approximately 83.5 degrees)

The focus of the signal beam may be placed precisely on the water's surface. At the design incidence angle of approximately 83.5 degrees, the signal beam will split into two equal intensity components. One of these will reflect off the water back into the air, and will be called the air beam. The other will refract into the water, and will be called the water beam. Both the air and water beams may be reflected back to the focus point by a spherical mirror 110 (EO 43-839). This mirror 110 may be placed so that its center-of-curvature (not its focus) coincides spatially with the signal beam focus. The mirror 110 may be on an aimable mechanical mount, of adjustable height, to achieve this (EO 39-929). The mirror 110 may be sufficiently “deep” so that both the air and water beams can fall upon it. If the radius of curvature is equal to or smaller than the diameter, this will be sufficient. Although the mirror 110 can be aimed to align the beams properly, it is held fixed during the recording of signals. Thus, the interferometer design described here differs substantially from other designs, in which the end reflector in one or both arms is allowed to move to produce a signal.

All the optical components may be mounted to an optical rail 140, e.g., the outside surface of a single piece of aluminum U-channel, the long dimension of which defines the optical axis. The optical axis is bent in this design, at the laser focus; due to the asymmetry in the reflection and refraction angles at the design incidence angle (the optical axis bisects the angle between the air and water beams). The U-channel may therefore also be bent, as shown in FIG. 1. The beam expander 130, polarizer 120, isolator 121, plate-beamsplitter 105, and focusing lens 115 may all be assembled into one unit via standard C-mount hardware (2 each of EO 54-611, 56-353, 54-639, 54-615). The aimable mounts for the laser 125 and the spherical mirror 110 may be shimmed to the proper height to align their central axes with the corresponding segments of the bent optical axis.

The vessel for holding the sample under study may allow for optical transmission of both the air and water beams, i.e. if it contains transmitting surfaces, they may be of optical quality. One way to do this is to fashion an extended collar of sheet aluminum around the mirror, held in place by a radiator hose clamp, which in turn compresses an O-ring stretched tightly around the mirror's edge. The collar may be of sufficient length to allow it to be filled with water up to the height of the focus. The collar is not a closed cylinder, but is open along its top edge, with a gap of 0.5-1 in. With this option, the optical surface of the mirror forms the lower end of the water vessel, and is wet when the vessel is filled. Furthermore, there are no transmitting surfaces in this water vessel. Another possibility would be a small hemispherical glass “bird-bath”. Two concentric hemispherical optical surfaces are figured in this vessel. This vessel is placed on a post and attached to the optical rail 140, such that the hemispheres' center is coincident with the laser focus. This vessel is made from silanized glass, to flatten the meniscus that would otherwise occur when the vessel is filled. With this option, the spherical mirror 110 remains dry, and the water beam is transmitted through two optical surfaces before reaching the mirror 110. However, since all rays incident upon these two optical surfaces will be at normal incidence by design, refractive effects will be minimized.

The air beam and the water beam, having been split by the abrupt increase in refractive index at the water's surface, will recombine when they return to the focus after reflection from the spherical mirror 110. Thus, in this design, the movable element, which causes the relative phase shifts between the two beams, is in fact also the thing which produced the two beams in the first place: the air-water interface at the free surface of the filled sample vessel. This results in an enhanced sensitivity, relative to the more typical procedure of allowing one of the return reflectors (the spherical mirror 110 in this case) to be movable. When the surface rises by a microscopic amount, the air beam is shortened while the water beam is lengthened, effectively doubling the phase shift between the air and water beams. After leaving the water's surface, the recombined signal beam travels back to the focusing lens 115 and is re-collimated. Upon reaching the plate beam splitter 105, half of the signal beam is steered out of the system in a direction opposite that of the reference beam. The remainder passes back thru the quarter-wave plate 135, becomes horizontally polarized, and is then blocked by the vertical polarizer 120.

It may also be possible to detect microscopic acoustic radiation from macromolecules and cells using other sensors and techniques. Capacitative Micromachined Ultrasonic Transducers (CMUTs) may be used within the bulk of a fluid sample, away from any air-water interface. Normal-incidence laser vibrometry could also be used at the air-water interface, with or without fiber optics, although it would be less sensitive since it essentially depends on stray reflections.

A mechanical isolation system is required to prevent external sources of acceleration from perturbing the sample. A standard pneumatic table is suitable (e.g., The MICRO-G #14088 from Kurashiki Corp.). The optical rail 140 may be placed on such a table, with the laser end elevated so as to achieve the proper angle of the source beam with the horizontal of 6.5 degrees. A glass or Lucite enclosure may be constructed around the entire apparatus to isolate it from air currents in the laboratory.

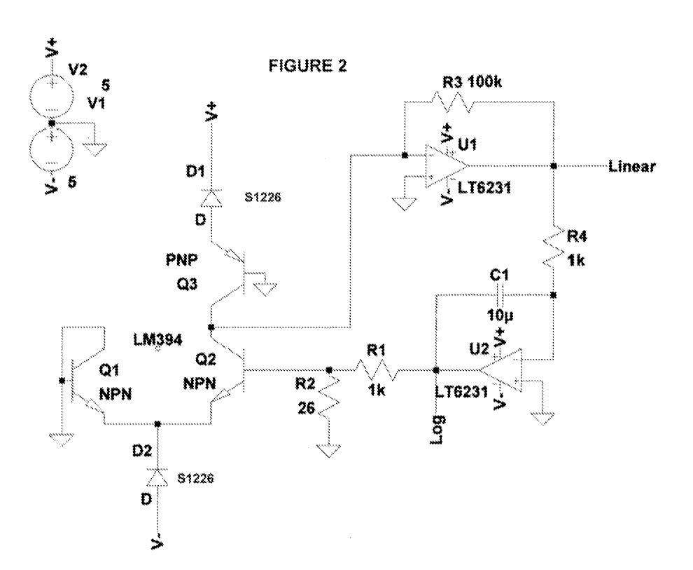

The signal and reference beams, after emerging in opposite directions from the plate beamsplitter 105, both horizontal and at right angles to the optical rail 140, may be steered so as to be incident on a pair of silicon PIN photodiodes (e.g., any of the Hamamatsu S1226 series). These form the sensing element in a noise-cancelling circuit shown schematically in FIG. 2. Mechanically, the photodiodes may be placed as close as possible to the noise cancelling circuitry to be described below, without long leads of any kind. Electrically, the photodiodes are arranged in series, with the signal current tapped off from the node between them (or rather between the cascoded PNP transistor Q3 and the signal path half of the adjustable current splitter, Q2). Thus, the signal (labeled “Linear” in FIG. 2) is proportional to the difference between the photocurrents due to the signal and reference, after amplification by the TIA formed from U1 and R3. U1 and U2 may be low-noise op-amps, preferably in a monolithic pair, such as the LT6231 from Linear Technology Inc., Milpitas, Calif. Since the reference beam is brighter than the signal beam by approximately a factor of four on average, the signal photodiode D1 cannot provide the entire photocurrent required by the reference photodiode D2. The reference photodiode draws the additional current it requires through half of a BJT matched pair (e.g., National Semiconductor LM394). The other half of the matched pair is in the current path between the photodiodes, and the two BJT's (Q1 and Q2) are connected such that the current through one is directly proportional to the current through the other, as shown in FIG. 2. The constant of proportionality is determined by the voltage difference between the two BJT bases, which in turn is determined through negative feedback from the signal output itself via U2. To provide this feedback, the “Linear” signal is fed through R4 to servo amplifier U2, which is locally open-looped at DC (capacitive feedback only, through C1). The “Linear” signal output is thus kept at an average value of zero by adjusting the voltage fed to the base of Q2 (through voltage divider R1 and R2, which prevents a possible lockup condition), out to a frequency determined by the bandwidth of the feedback circuit (less than a few kHz). Since the signal and reference beams are in fact from the same coherent source, their residual intensity noise (RIN) contributions are also proportional to each other. Thus, by balancing the signal and reference photocurrents at low frequencies, the RIN can be cancelled throughout the bandwidth in which the BJT's remain well-matched (0-100 MHz, typically), which more than covers the bandwidth of interest (0-10 MHz).

It is also possible to cancel RIN in digital data, or via divider circuitry, again using the signal and reference beams. Whatever method is used, the effects of RIN may be reduced by 40 dB or more in order to detect acoustic radiation from microscopic sources.

A signal proportional to the amount of negative feedback required to cancel the RIN is available as a second output (labeled “Log” in FIG. 2). This signal essentially tracks low-frequency mechanical perturbations to the water surface. It can be used to cancel out these perturbations, and to hold the signal beam to a constant mid-level intensity, by using it as an error signal with which to drive a high-voltage sharp-tipped electrode held within 0.5 mm of the water surface, directly above the laser focus. The tip may be held at an average DC level of approximately 150 V, with perturbations proportional to the force required to steady the water's surface. These can be provided by a standard high-voltage differential amplifier, such as the Matsusada AMS 0.6B50 (Matsusada Precision Inc., Kusatsu City, Japan). The precise perturbation needed is indicated by the error signal (“Log” in FIG. 2). The DC level lifts the surface slightly (<1 micron), so that if a downward force is required to keep the surface stationary, it can be provided by surface tension. The lifting occurs due to the attractive force exerted on the electric dipole moments of individual water molecules towards a region of stronger electric field, such as that found near a sharp-tipped electrode.

Steady acoustic radiation due to macromolecular (or larger) sources in water is expected to occur at frequencies below 10 MHz, with the upper limit determined by the viscosity of water and typical source sizes and energies. Thus a high speed digitization system with a sample rate of 20 MHz or more (e.g., the NI-5102 from National Instruments, Dallas, Tex.) may be used to sample the signal output.

1. An acoustic radiation detecting apparatus and method as shown and described.
